(19) United States
(12) Patent Application Publication
(10) Pub. No.: US 2025/0245851 A1
(43) Pub. Date: Jul. 31, 2025

(54) Map-Relative Pose Regression for Visual Relocalization

(71) Applicant: Niantic, Inc., San Francisco, CA (US)

(72) Inventors: Shuai Chen, London (GB); Tommaso Cavallari, Oxford (GB); Victor Adrian Prisacariu, Oxford (GB); Eric Brachmann, Hanover (DE)

(21) Appl. No.: 19/038,488

(22) Filed: Jan. 27, 2025

Related U.S. Application Data
(60) Provisional application No. 63/625,151, filed on Jan. 25, 2024.

(51) Int. Cl. G06T 7/70; A63F 13/213; A63F 13/655; G06V 10/82

(52) U.S. Cl. CPC G06T 7/70; A63F 13/213; A63F 13/655; G06V 10/82; A63F 2300/8082; G06T 2207/20081; G06T 2207/20084; G06T 2207/30244

(57) ABSTRACT

This disclosure pertains to a scene-agnostic, map-relative pose regression method. The pose regressor is conditioned on a scene-specific map representation such that its pose predictions are relative to the scene map. This allows training of the pose regressor across multiple scenes to learn the generic relation between a scene-specific map representation and the camera pose. The map-relative pose regressor can then be applied to new map representations.

### BACKGROUND

### 1. Technical Field

The subject matter described relates generally to augmented reality, and, in particular, to camera pose estimation.

### 2. Problem

Pose regression networks predict the camera pose of a query image relative to a known environment. Within this family of methods, absolute pose regression (APR) has recently shown promising accuracy in the range of a few centimeters in position error. APR networks encode the scene geometry implicitly in their weights. To achieve high accuracy, they require vast amounts of training data that, realistically, can only be created using novel view synthesis in a days-long process. This process is repeated for each new scene again and again. That is, the training data for train a conventional APR-based pose regression network requires a large amount of storage resources. Also, training the conventional APR-based pose regression network using the training data requires a large amount of computing resources. This process is also slow and takes a large amount of time. A better approach that leverages the simplicity and efficiency of APR while increasing computational efficiency and requiring less use of computing resources is desirable.

### SUMMARY

This disclosure pertains to a pose estimation network for predicting the pose of a camera that captured an input image. In various embodiments, the pose estimation network includes a scene-specific scene geometry prediction network and a scene-agnostic, map-relative pose regressor for camera pose estimation without using 3D mapping (e.g., depth map, point clouds, mesh, and the like). The pose regressor is conditioned on a scene-specific map representation generated by the scene-specific scene geometry prediction network such that its pose predictions are relative to the scene map. This allows training of the pose regressor across a plurality of scenes to learn the generic relation between a scene-specific map representation and the camera pose. The map-relative pose regressor can then be applied to new map representations immediately.

In one embodiment, a computer-implemented method for determining a camera pose includes obtaining an image of a scene captured by a camera and inputting the image into a first machine-learned model. The first machine-learned model is trained to predict a 3D coordinate map of the scene by mapping 2D pixels from the image to 3D scene coordinates. The method also includes inputting the 3D coordinate map of the scene into a second machine-learned model that is trained to estimate a pose of the camera when capturing the image of the scene based on the 3D coordinate map. The method further includes causing display of a virtual element at a position on a display of a client device (e.g., as part of an augmented reality experience in a game). The position is determined based on the pose of the camera estimated by the second machine-learned model.

In some embodiments, the image is an RGB image, and the second machine-learned model estimates the pose of the camera without requiring a depth map or a point-cloud model of the image of the scene captured by the camera. The first machine-learned model may be a scene-specific geometry-based prediction model (e.g., a convolutional neural network) that processes the captured image to predict the 3D coordinate map. The first machine-learned model can be trained specifically for the scene based on training data associated with the scene.

In some embodiments, the method also includes inputting a camera intrinsic matrix associated with the captured image into the second machine-learned model. The second machine-learned model may be a scene-agnostic pose regressor model (e.g., a transformer) that directly regresses a multi-dimensional pose vector for the captured image of the scene based on the 3D coordinate map and the camera intrinsic matrix associated with the captured image. The method may also include training the second machine-learned model using training data including 3D coordinate maps of multiple historical scenes and corresponding ground truth camera poses. The second machine-learned model can be agnostic to the scene.

In some embodiments, the pose of the camera indicates a position and an orientation of the camera relative to the 3D coordinate map of the scene, and the method also includes transmitting game data to the client device including the camera, the game data based on the pose of the camera. The first machine-learned model may be a scene-specific geometry-based prediction model trained on images of the scene and the second machine-learned model may be a scene-agnostic transformer model trained on images of a plurality of other scenes

### BRIEF DESCRIPTION OF THE DRAWINGS

FIG. 1 depicts a representation of a virtual world having a geography that parallels the real world, according to one embodiment.

FIG. 2 depicts an exemplary interface of a parallel reality game, according to one embodiment.

FIG. 3 is a block diagram of a networked computing environment suitable for camera pose estimation, according to one embodiment.

FIG. 4 is a block diagram of the pose regression engine shown in FIG. 3, according to one embodiment.

FIG. 5 illustrates the architecture of a pose estimation network that includes a scene-specific scene geometry prediction network and a scene-agnostic, map-relative pose regressor, according to one embodiment.

FIG. 6 illustrates the architecture of the scene-agnostic, map-relative pose regressor of FIG. 5, according to one embodiment

FIG. 7 is a flowchart of a process for displaying virtual content using camera pose estimation, according to one embodiment.

FIG. 8 illustrates an example computer system suitable for use in the networked computing environment of FIG. 1, according to one embodiment.

### DETAILED DESCRIPTION

The figures and the following description describe certain embodiments by way of illustration only. One skilled in the art will recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

Various embodiments are described in the context of a parallel reality game that includes augmented reality content in a virtual world geography that parallels at least a portion of the real-world geography such that player movement and actions in the real-world affect actions in the virtual world. However, the subject matter described is applicable in other situations where camera pose estimation is desirable. In addition, the inherent flexibility of computer-based systems allows for a great variety of possible configurations, combinations, and divisions of tasks and functionality between and among the components of the system.

### Example Location-Based Parallel Reality Game

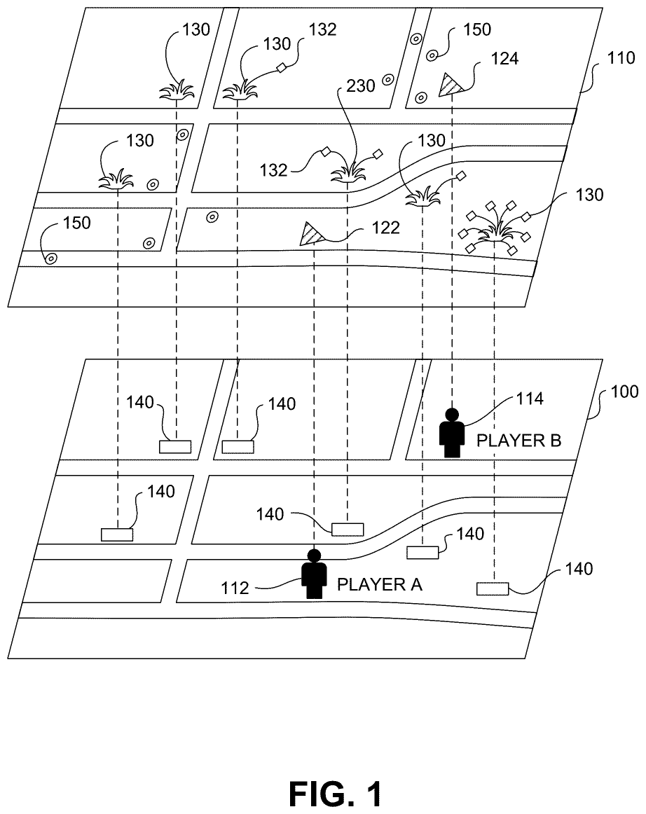

FIG. 1 is a conceptual diagram of a virtual world 110 that parallels the real world 100. The virtual world 110 can act as the game board for players of a parallel reality game. As illustrated, the virtual world 110 includes a geography that parallels the geography of the real world 100. In particular, a range of coordinates defining a geographic area or space in the real world 100 is mapped to a corresponding range of coordinates defining a virtual space in the virtual world 110. The range of coordinates in the real world 100 can be associated with a town, neighborhood, city, campus, locale, a country, continent, the entire globe, or other geographic area. Each geographic coordinate in the range of geographic coordinates is mapped to a corresponding coordinate in a virtual space in the virtual world 110.

A player's position in the virtual world 110 corresponds to the player's position in the real world 100. For instance, player A located at position 112 in the real world 100 has a corresponding position 122 in the virtual world 110. Similarly, player B located at position 114 in the real world 100 has a corresponding position 124 in the virtual world 110. As the players move about in a range of geographic coordinates in the real world 100, the players also move about in the range of coordinates defining the virtual space in the virtual world 110. In particular, a positioning system (e.g., a GPS system, a localization system, or both) associated with a mobile computing device carried by the player can be used to track a player's position as the player navigates the range of geographic coordinates in the real world 100. Data associated with the player's position in the real world 100 is used to update the player's position in the corresponding range of coordinates defining the virtual space in the virtual world 110. In this manner, players can navigate along a continuous track in the range of coordinates defining the virtual space in the virtual world 110 by simply traveling among the corresponding range of geographic coordinates in the real world 100 without having to check in or periodically update location information at specific discrete locations in the real world 100.

The location-based game can include game objectives requiring players to travel to or interact with various virtual elements or virtual objects scattered at various virtual locations in the virtual world 110. A player can travel to these virtual locations by traveling to the corresponding location of the virtual elements or objects in the real world 100. For instance, a positioning system can track the position of the player such that as the player navigates the real world 100, the player also navigates the parallel virtual world 110. The player can then interact with various virtual elements and objects at the specific location to achieve or perform one or more game objectives.

A game objective may have players interacting with virtual elements 130 located at various virtual locations in the virtual world 110. These virtual elements 130 can be linked to landmarks, geographic locations, or objects 140 in the real world 100. The real-world landmarks or objects 140 can be works of art, monuments, buildings, businesses, libraries, museums, or other suitable real-world landmarks or objects. Interactions include capturing, claiming ownership of, using some virtual item, spending some virtual currency, etc. To capture these virtual elements 130, a player travels to the landmark or geographic locations 140 linked to the virtual elements 130 in the real world and performs any necessary interactions (as defined by the game's rules) with the virtual elements 130 in the virtual world 110. For example, player A may have to travel to a landmark 140 in the real world 100 to interact with or capture a virtual element 130 linked with that particular landmark 140. The interaction with the virtual element 130 can require action in the real world, such as taking a photograph or verifying, obtaining, or capturing other information about the landmark or object 140 associated with the virtual element 130.

Game objectives may require that players use one or more virtual items that are collected by the players in the location-based game. For instance, the players may travel the virtual world 110 seeking virtual items 132 (e.g., weapons, creatures, power ups, or other items) that can be useful for completing game objectives. These virtual items 132 can be found or collected by traveling to different locations in the real world 100 or by completing various actions in either the virtual world 110 or the real world 100 (such as interacting with virtual elements 130, battling non-player characters or other players, or completing quests, etc.). In the example shown in FIG. 1, a player uses virtual items 132 to capture one or more virtual elements 130. In particular, a player can deploy virtual items 132 at locations in the virtual world 110 near to or within the virtual elements 130. Deploying one or more virtual items 132 in this manner can result in the capture of the virtual element 130 for the player or for the team/faction of the player.

In one particular implementation, a player may have to gather virtual energy as part of the parallel reality game. Virtual energy 150 can be scattered at different locations in the virtual world 110. A player can collect the virtual energy 150 by traveling to (or within a threshold distance of) the location in the real world 100 that corresponds to the location of the virtual energy in the virtual world 110. The virtual energy 150 can be used to power virtual items or perform various game objectives in the game. A player that loses all virtual energy 150 may be disconnected from the game or prevented from playing for a certain amount of time or until they have collected additional virtual energy 150.

According to aspects of the present disclosure, the parallel reality game can be a massive multi-player location-based game where every participant in the game shares the same virtual world. The players can be divided into separate teams or factions and can work together to achieve one or more game objectives, such as to capture or claim ownership of a virtual element. In this manner, the parallel reality game can intrinsically be a social game that encourages cooperation among players within the game. Players from opposing teams can work against each other (or sometime collaborate to achieve mutual objectives) during the parallel reality game. A player may use virtual items to attack or impede progress of players on opposing teams. In some cases, players are encouraged to congregate at real world locations for cooperative or interactive events in the parallel reality game. In these cases, the game server seeks to ensure players are indeed physically present and not spoofing their locations.

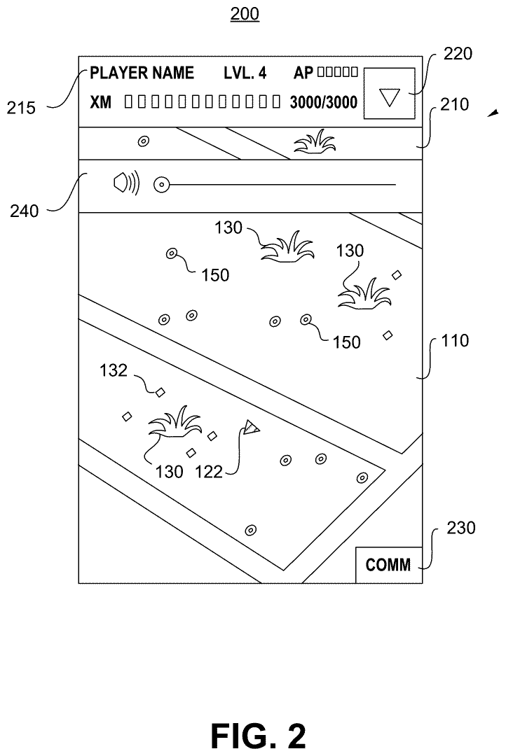

FIG. 2 depicts one embodiment of a game interface 200 that can be presented (e.g., on a player's smartphone) as part of the interface between the player and the virtual world 110. The game interface 200 includes a display window 210 that can be used to display the virtual world 110 and various other aspects of the game, such as player position 122 and the locations of virtual elements 130, virtual items 132, and virtual energy 150 in the virtual world 110. The user interface 200 can also display other information, such as game data information, game communications, player information, client location verification instructions and other information associated with the game. For example, the user interface can display player information 215, such as player name, experience level, and other information. The user interface 200 can include a menu 220 for accessing various game settings and other information associated with the game. The user interface 200 can also include a communications interface 230 that enables communications between the game system and the player and between one or more players of the parallel reality game.

According to aspects of the present disclosure, a player can interact with the parallel reality game by carrying a client device around in the real world. For instance, a player can play the game by accessing an application associated with the parallel reality game on a smartphone and moving about in the real world with the smartphone. In this regard, it is not necessary for the player to continuously view a visual representation of the virtual world on a display screen in order to play the location-based game. As a result, the user interface 200 can include non-visual elements that allow a user to interact with the game. For instance, the game interface can provide audible notifications to the player when the player is approaching a virtual element or object in the game or when an important event happens in the parallel reality game. In some embodiments, a player can control these audible notifications with audio control 240. Different types of audible notifications can be provided to the user depending on the type of virtual element or event. The audible notification can increase or decrease in frequency or volume depending on a player's proximity to a virtual element or object. Other non-visual notifications and signals can be provided to the user, such as a vibratory notification or other suitable notifications or signals.

The parallel reality game can have various features to enhance and encourage game play within the parallel reality game. For instance, players can accumulate a virtual currency or another virtual reward (e.g., virtual tokens, virtual points, virtual material resources, etc.) that can be used throughout the game (e.g., to purchase in-game items, to redeem other items, to craft items, etc.). Players can advance through various levels as the players complete one or more game objectives and gain experience within the game. Players may also be able to obtain enhanced “powers” or virtual items that can be used to complete game objectives within the game.

Those of ordinary skill in the art, using the disclosures provided, will appreciate that numerous game interface configurations and underlying functionalities are possible. The present disclosure is not intended to be limited to any one particular configuration unless it is explicitly stated to the contrary.

### Example Gaming System

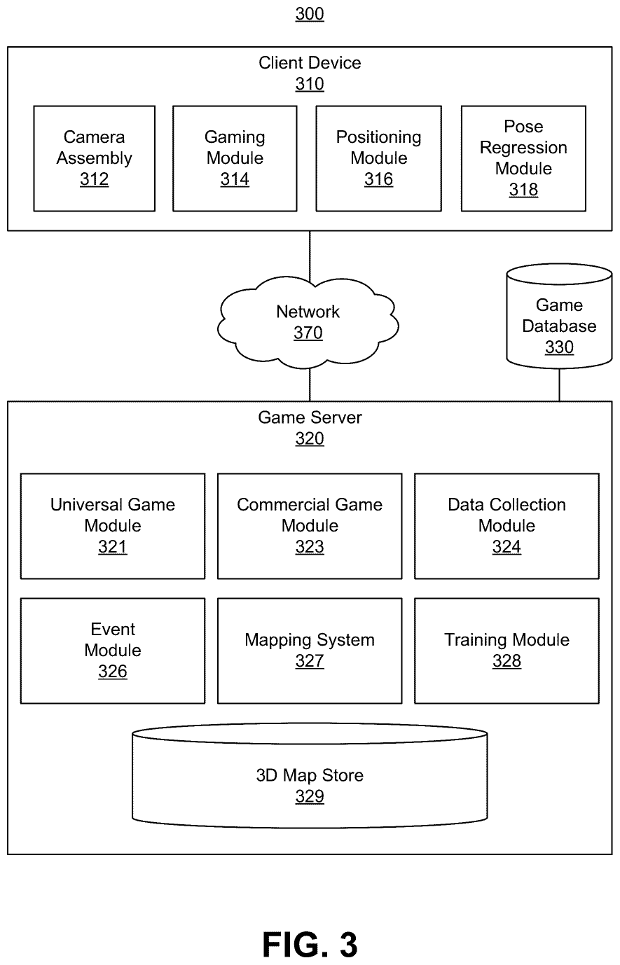

FIG. 3 illustrates one embodiment of a networked computing environment 300. The networked computing environment 300 uses a client-server architecture, where a game server 320 communicates with a client device 310 over a network 370 to provide a parallel reality game to a player at the client device 310. The networked computing environment 300 also may include other external systems such as sponsor/advertiser systems or business systems. Although only one client device 310 is shown in FIG. 3, any number of client devices 310 or other external systems may be connected to the game server 320 over the network 370. Furthermore, the networked computing environment 300 may contain different or additional elements and functionality may be distributed between the client device 310 and the server 320 in different manners than described below. For example, some or all of the functionality of a pose regression module 318 may be implemented at the server 320, with a client device 310 sending one or more images captured by a camera of the client device to the server 320 for analysis.

The networked computing environment 300 provides for the interaction of players in a virtual world having a geography that parallels the real world. In particular, a geographic area in the real world can be linked or mapped directly to a corresponding area in the virtual world. A player can move about in the virtual world by moving to various geographic locations in the real world. For instance, a player's position in the real world can be tracked and used to update the player's position in the virtual world. Typically, the player's position in the real world is determined by finding the location of a client device 310 through which the player is interacting with the virtual world and assuming the player is at the same (or approximately the same) location. For example, in various embodiments, the player may interact with a virtual element if the player's location in the real world is within a threshold distance (e.g., ten meters, twenty meters, etc.) of the real-world location that corresponds to the virtual location of the virtual element in the virtual world. For convenience, various embodiments are described with reference to “the player's location” but one of skill in the art will appreciate that such references may refer to the location of the player's client device 310.

A client device 310 can be any portable computing device capable for use by a player to interface with the game server 320. For instance, a client device 310 is preferably a portable wireless device that can be carried by a player, such as a smartphone, portable gaming device, augmented reality (AR) headset, cellular phone, tablet, personal digital assistant (PDA), navigation system, handheld GPS system, or other such device. For some use cases, the client device 310 may be a less-mobile device such as a desktop or a laptop computer. Furthermore, the client device 310 may be a vehicle with a built-in computing device.

The client device 310 communicates with the game server 320 to provide sensory data of a physical environment. In one embodiment, the client device 310 includes a camera assembly 312, a gaming module 314, a positioning module 316, and a pose regression module 318. The client device 310 also includes a network interface (not shown) for providing communications over the network 370. In various embodiments, the client device 310 may include different or additional components, such as additional sensors, display, and software modules, etc.

The camera assembly 312 includes one or more cameras which can capture image data. The cameras capture image data describing a scene of the environment surrounding the client device 310 with a particular pose (the location and orientation of the camera within the environment). The camera assembly 312 may use a variety of photo sensors with varying color capture ranges and varying capture rates. Similarly, the camera assembly 312 may include cameras with a range of different lenses, such as a wide-angle lens or a telephoto lens. The camera assembly 312 may be configured to capture single images or multiple images as frames of a video.

The client device 310 may also include additional sensors for collecting data regarding the environment surrounding the client device, such as movement sensors, accelerometers, gyroscopes, barometers, thermometers, light sensors, microphones, etc. The image data captured by the camera assembly 312 can be appended with metadata describing other information about the image data, such as additional sensory data (e.g., temperature, brightness of environment, air pressure, location, pose, etc.), capture data (e.g., exposure length, shutter speed, focal length, capture time, etc.).

The gaming module 314 provides a player with an interface to participate in the parallel reality game. The game server 320 transmits game data over the network 370 to the client device 310 for use by the gaming module 314 to provide a local version of the game to a player at locations remote from the game server. In one embodiment, the gaming module 314 presents a user interface on a display of the client device 310 that depicts a virtual world (e.g., renders imagery of the virtual world) and allows a user to interact with the virtual world to perform various game objectives. In some embodiments, the gaming module 314 presents images of the real world (e.g., captured by the camera assembly 312) augmented with virtual elements from the parallel reality game. In these embodiments, the gaming module 314 may generate or adjust virtual content according to other information received from other components of the client device 310. For example, the gaming module 314 may adjust a virtual object to be displayed on the user interface according to a depth map of the scene captured in the image data.

The gaming module 314 can also control various other outputs to allow a player to interact with the game without requiring the player to view a display screen. For instance, the gaming module 314 can control various audio, vibratory, or other notifications that allow the player to play the game without looking at the display screen.

The positioning module 316 can be any device or circuitry for determining the position of the client device 310. For example, the positioning module 316 can determine actual or relative position by using a satellite navigation positioning system (e.g., a GPS system, a Galileo positioning system, the Global Navigation satellite system (GLONASS), the BeiDou Satellite Navigation and Positioning system), an inertial navigation system, a dead reckoning system, IP address analysis, triangulation and/or proximity to cellular towers or Wi-Fi hotspots, or other suitable techniques.

As the player moves around with the client device 310 in the real world, the positioning module 316 tracks the position of the player and provides the player position information to the gaming module 314. The gaming module 314 updates the player position in the virtual world associated with the game based on the actual position of the player in the real world. Thus, a player can interact with the virtual world simply by carrying or transporting the client device 310 in the real world. In particular, the location of the player in the virtual world can correspond to the location of the player in the real world. The gaming module 314 can provide player position information to the game server 320 over the network 370. In response, the game server 320 may enact various techniques to verify the location of the client device 310 to prevent cheaters from spoofing their locations. It should be understood that location information associated with a player is utilized only if permission is granted after the player has been notified that location information of the player is to be accessed and how the location information is to be utilized in the context of the game (e.g., to update player position in the virtual world). In addition, any location information associated with players is stored and maintained in a manner to protect player privacy.

The pose regression module 318 provides an additional or alternative way to determine the location of the client device 310. In one embodiment, the pose regression module 318 uses a pose estimation network that includes a scene-specific scene geometry prediction network and a scene-agnostic, map-relative pose regressor for regression-based camera pose estimation and visual relocalization. Visual relocalization refers to the task of building a scene representation based on a given a set of mapping images and their poses, expressed in a common coordinate system, and later, given a query image, estimating its pose, i.e., position and orientation of the camera assembly 312 that captured the query image, relative to the scene.

The pose estimation network combines a scene-agnostic map-relative pose regression method with a scene-specific metric representation. That is, the network couples a scene-specific representation—encoding the scale-metric reference space of each target scene—with a general, scene-agnostic, absolute pose regression (APR) network. As a result, the pose regression module 318 can perform end-to-end inference on previously unseen images and, due to the explicit 3D geometric knowledge encoded by the scene-specific component, the pose regression module 318 can directly estimate accurate, absolute, metric poses without utilizing 3D maps required by geometric-based approaches.

In some embodiments, the scene-specific scene representation is generated by a model trained individually for each scene (e.g., by the pose regression module 318 or as a service on demand by training module 328 of the game server 320) while the scene-agnostic part of the model is trained in advance (e.g., by the training module 328) and provided to the client device 310 in advance. A query image captured by the camera assembly 312 may first be input to the scene-specific geometry prediction submodule to predict a scene coordinate map. A fast-training scene coordinate regression (SCR) model may be utilized for the scene-specific geometry prediction submodule to generate the scene representation.

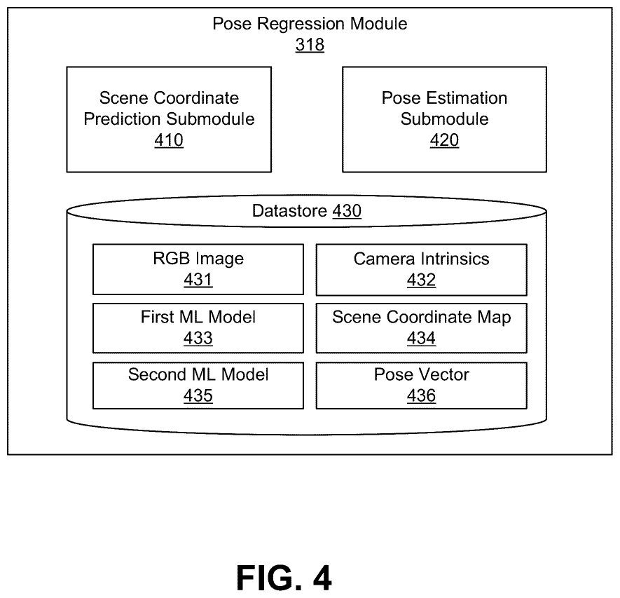

FIG. 4 illustrates one embodiment of the pose regression module 318 that uses such an architecture. In the embodiment shown, the pose regression module 318 includes a scene coordinate prediction submodule 410, a pose estimation submodule 420, and a datastore 430, which stores one or more RGB images 431, camera intrinsics 432, a first machine learning (ML) model 433, a scene coordinate map 434, a second ML model 435, and a pose vector 436. In other embodiments, the pose regression module 318 may include different or additional elements. In addition, the functions may be distributed among the elements in a different manner than described.

The scene coordinate prediction submodule 410 receives an input image (e.g., captured by the camera assembly 312 of a client device 310) and predicts a 3D geometry of the scene depicted in the input image. In one embodiment, the scene coordinate prediction submodule 410 maps pixels from the input image to 3D scene coordinates using a scene-specific ML model that was previously trained on a set of training images of the scene. For example, the scene-specific submodule of the pose regression module 318 may be a convolutional neural network-based (CNN) scene geometry prediction network, G, that maps pixels from the input image captured by the camera assembly 312 to 3D scene coordinates. The network G may be designed to associate each input image to scene-specific 3D information, thus requiring some training process for every new scene processed by the network. Any algorithm capable of predicting 3D scene coordinates from an input image may be implemented as the network G of the scene coordinate prediction submodule 410.

The pose estimation submodule 420 applies a scene-agnostic model that takes as input the 3D scene coordinates predicted by the scene coordinate prediction submodule 410 and outputs an estimated pose for the input image. In one embodiment, the scene agnostic model is a scene-agnostic map-relative pose regressor with a transformer-based network architecture that can process a dense set of correspondences between 2D locations in a query image captured by the camera assembly 312 and their corresponding 3D coordinates within the reference system of a previously mapped scene, and estimate the pose of the client device 310 that captured the query image. The pose estimation submodule 420 thus addresses the limitations of previous APR techniques, offering both scalability and precision in predicting accurate scale-metric poses across diverse scenes without requiring scene-specific training for the pose regressor component.

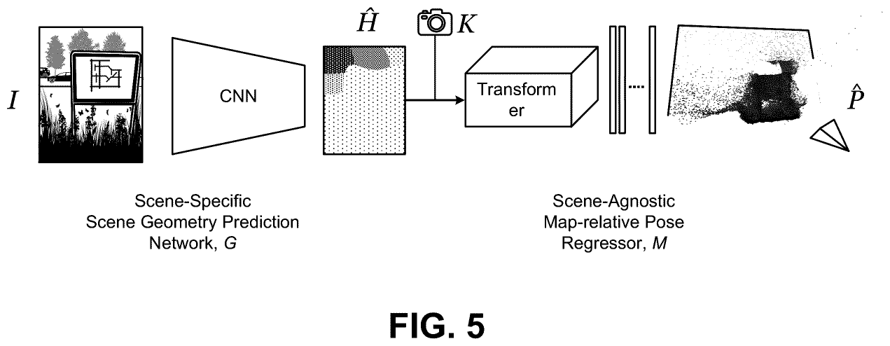

FIG. 5 illustrates the architecture of an example pose estimation network that includes a scene-specific scene geometry prediction network, G, and a scene-agnostic, map-relative pose regressor, M. The scene-specific scene geometry prediction network, G, processes an input image to predict a scene coordinate map, Ĥ. Then, the scene-agnostic, map-relative pose regressor, M, is used to regress the camera pose from the coordinate map Ĥ. The map-relative pose regressor may also take the camera intrinsics, K, as input.

The map-relative pose regressor, M, may be any model configured to estimate camera poses from scene coordinates generated by the scene geometry prediction network, G. In one embodiment, the map-relative pose regressor has a transformer-based architecture. The map-relative pose regressor M may be a scene-agnostic model trained with large amounts of data that can generalize to unseen maps. The predicted scene coordinate map output of the scene geometry prediction network G may be input to the scene-agnostic map-relative pose regressor M to directly regress the camera pose. As noted previously, in addition to the scene representation output of the scene geometry prediction network, camera intrinsics representing the intrinsic properties of the camera assembly 312 of the client device 310 that captured the query frame may also be input to the scene agnostic, map-relative pose regressor M. In some embodiments, the scene-agnostic map-relative pose regressor M may be fine tuned on one or more images of the specific scene. Because the scene-agnostic map-relative pose regressor M is largely trained in advance, the fine tuning can be done quickly with relatively little additional training data.

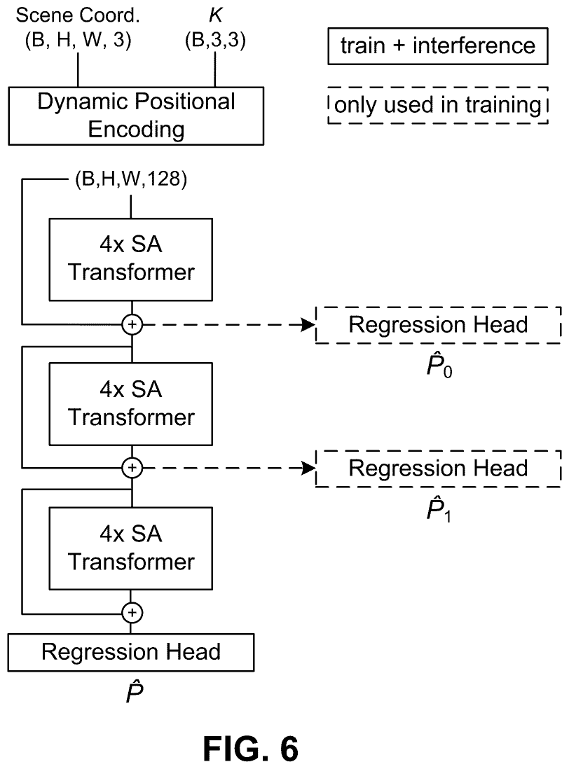

FIG. 6 illustrates an example transformer-based architecture for the scene-agnostic, map-relative pose regressor, according to one embodiment. In the embodiment shown, the map-relative pose regressor takes as input a tensor of predicted scene coordinate maps (e.g., as produced by the scene geometry prediction, G) and the corresponding camera intrinsics. The map-relative pose regressor embeds the information with dynamic positional encoding into higher dimensional features and estimates camera poses, \hat{P}.

The transformers may be designed to interpret 3D geometric information that is strongly connected to real-world physics. The content a camera captures in its frame is strictly associated with its intrinsic parameters. Thus, a positional encoding that is conditioned on each individual sensor enables training of the main transformer blocks in a fashion that is independent of the camera calibration parameters. In one embodiment, the positional encoding entails the fusion of two different components: (1) a camera-aware 2D positional embedding, associating each predicted scene coordinate to its corresponding pixel location; and (2) a 3D positional embedding that embeds the actual 3D scene coordinate values into a high-frequency domain.

The positional embedding may integrate information from the camera's intrinsics to generate high-frequency components that are fed to the transformer network. In one embodiment, for each pixel coordinate (u, v) in the input image, the encoding scheme first computes the (x, y) components of the 3D ray originating in the camera center and passing through the pixel (ignoring the z component) and then applies a positional embedding on the (now camera-invariant) ray's directional components. This generates a high-frequency/high-dimensionality embedding, allowing the transformer to correlate the input 3D coordinates (predicted by the scene geometry prediction network, G, and defined in a scene-specific coordinate system) with 3D rays originating from the current camera position, helping with the task of regressing the current camera pose with respect to the origin of the scene coordinate system.

The 2D camera-aware positional embedding may be formally defined as:

$$P {E}_{2 D ( u , v )}^{i} := \{ \begin{matrix}sin ( {ω}_{k} \cdot {X}_{ray} ( u ) ) , & i = 4 k \\ cos ( {ω}_{k} \cdot {X}_{ray} ( u ) ) , & i = 4 k + 1 \\ sin ( {ω}_{k} \cdot {Y}_{ray} ( v ) ) , & i = 4 k + 2 \\ cos ( {ω}_{k} \cdot {Y}_{ray} ( v ) ) , & i = 4 k + 3\end{matrix}$$

where

$${ω}_{k} = \frac{1}{{10000}^{2 k / d}}$$

is the frequency band defined for d-dimensional features in which positional encoding is applied, i is the current feature index, and X_{ray} and Y_{ray} are the X and Y components of the rays passing through (u,v):

$${X}_{r a y} ( u ) = λ \frac{u - {c}_{x} - ε}{{f}_{x}}$$

$${Y}_{r a y} ( v ) = λ \frac{v - {c}_{y} - ε}{{f}_{y}}$$

with f_{x/y} and c_{x/y} corresponding to the intrinsics of the input image, E being a constant (e.g., 0.5 to achieve zero mean in the center of the image), and λ being a second constant (e.g., 400 being chosen heuristically to keep a reasonable numeric magnitude for the embedding).

A 3D positional embedding may be used to map scene coordinates pϵ [symbol] predicted by scene geometry prediction network, G, to high frequency/dimensionality:

$$P {E}_{3 D} ( p ) = C o n {v}_{3 ( 2 m + 1 )}^{d} [ p , sin ( {2}^{0} π p ) , cos ( {2}^{0} π p ) , … , sin ( {2}^{m - 1} π p ) , cos ( {2}^{m - 1} π p ) ]$$

Here, in addition to the sinusoidal embedding mapping the 3D coordinates to a 3(2m+1) dimensional space, a further 1×1 convolution (Conv₆ₘ₊₃^{d}) may also be applied to ensure both PE_{2D} and PE_{3D} have the same number of channels. The 2D and 3D embeddings may be fused before passing them to the transformer, e.g.: PE_{f}=PE_{3D}+PE_{2D}.

As shown in FIG. 6, the core of map-relative pose regression architecture can include twelve self-attenuation transformers arranged in three blocks of four transformers each, but other numbers and groupings of transformers may be used. In one embodiment, linear transformers are used as this reduces the computational complexity of each layer from quadratic to linear in the length of input (i.e., the resolution of the scene coordinate map), providing good scaling for higher resolution coordinate maps. In some embodiments, because the dynamic positional encoding is only fed to the first transformer directly, a re-attention mechanism that introduces residual connections every four transformer blocks may be used to aid the network to more quickly converge. This can also lead to trained models that generalize more reliably.

The regression head generates a single embedding that represents the whole input scene-coordinate map. In one embodiment, the regression head includes a residual block formed of three 1×1 convolution layers followed by a global average pooling layer that generates the single embedding. The single embedding is then passed to a small Multi-Layer Perceptron (MLP), e.g. with 3 layers, that outputs the camera pose, e.g., as a 10-dimensional representation. The pose representation can then be unpacked into translation and rotation: the translation can be represented by four homogeneous coordinates and the rotation can be encoded as a 6D vector representing two un-normalized axes of the coordinate system that are later used to form a full rotation matrix by normalization and calculating the cross-product. However, it should be appreciated that other embodiments may use any suitable mathematical representation of translation and rotation.

The map-relative pose regressor architecture described above can directly output a metric pose, \hat{P}, for each input image. Each metric pose may be formed of a 3×3 rotation matrix, \hat{R}, and a translation matrix, \hat{t}. The pose regressor may be trained using an L1 pose regression loss defined as [symbol] _{\hat{P}}=∥\hat{R}−R∥₁+∥\hat{t}−t∥₁.

Supervision may be added at intermediate layers of the regressor. During training, the pose regression head may be applied after each group of (e.g., 4) self-attention transformers to compute auxiliary losses (as shown in FIG. 6), [symbol] _{\hat{P}0} and [symbol] _{\hat{P}1}. Thus, the total loss during training can be taken by adding the three losses, [symbol] _{\hat{P}}, [symbol] _{\hat{P}0}, and [symbol] _{\hat{P}1}. Conversely, at inference time, embodiments may use just the final output pose, \hat{P}.

The scene-agnostic map-relative pose regressor may be trained in advance to learn the relationship between a scene coordinate prediction and the corresponding camera pose. This allows training of the pose regressor on hundreds of different scenes, effectively solving the issue of limited availability of large amounts of scene-specific training data afflicting conventional APR approaches. On the other hand, since at localization time, the scene-agnostic, map-relative pose regressor is conditioned on a scene-specific map representation (i.e., network G), it can predict accurate scale-metric poses, unlike conventional relative pose regressors. Thus, the pose regression module 318 can rely on RGB images and camera intrinsics without requiring depth information or pre-built point clouds for camera pose estimation.

Referring back to FIG. 3, after pose estimation by the localization module 318, the position of the client device 310 can then be tracked over time using dead reckoning based on sensor readings, periodic re-localization (e.g., periodic pose re-estimation by the localization module 318), or a combination of both. Having an accurate pose for the client device 310 may enable the gaming module 314 to present virtual content overlaid on images of the real world (e.g., by displaying virtual elements in conjunction with a real-time feed from the camera assembly 312 on a display) or the real world itself (e.g., by displaying virtual elements on a transparent display of an AR headset) in a manner that gives the impression that the virtual objects are interacting with the real world. For example, a virtual character may hide behind a real tree, a virtual hat may be placed on a real statue, or a virtual creature may run and hide if a real person approaches it too quickly.

The game server 320 includes one or more computing devices that provide game functionality to the client device 310. The game server 320 can include or be in communication with a game database 330. The game database 330 stores game data used in the parallel reality game to be served or provided to the client device 310 over the network 370.

The game data stored in the game database 330 can include: (1) data associated with the virtual world in the parallel reality game (e.g., image data used to render the virtual world on a display device, geographic coordinates of locations in the virtual world, etc.); (2) data associated with players of the parallel reality game (e.g., player profiles including but not limited to player information, player experience level, player currency, current player positions in the virtual world/real world, player energy level, player preferences, team information, faction information, etc.); (3) data associated with game objectives (e.g., data associated with current game objectives, status of game objectives, past game objectives, future game objectives, desired game objectives, etc.); (4) data associated with virtual elements in the virtual world (e.g., positions of virtual elements, types of virtual elements, game objectives associated with virtual elements; corresponding actual world position information for virtual elements; behavior of virtual elements, relevance of virtual elements etc.); (5) data associated with real-world objects, landmarks, positions linked to virtual-world elements (e.g., location of real-world objects/landmarks, description of real-world objects/landmarks, relevance of virtual elements linked to real-world objects, etc.); (6) game status (e.g., current number of players, current status of game objectives, player leaderboard, etc.); (7) data associated with player actions/input (e.g., current player positions, past player positions, player moves, player input, player queries, player communications, etc.); or (8) any other data used, related to, or obtained during implementation of the parallel reality game. The game data stored in the game database 330 can be populated either offline or in real time by system administrators or by data received from users (e.g., players), such as from a client device 310 over the network 370.

In one embodiment, the game server 320 is configured to receive requests for game data from a client device 310 (for instance via remote procedure calls (RPCs)) and to respond to those requests via the network 370. The game server 320 can encode game data in one or more data files and provide the data files to the client device 310. In addition, the game server 320 can be configured to receive game data (e.g., player positions, player actions, player input, etc.) from a client device 310 via the network 370. The client device 310 can be configured to periodically send player input and other updates to the game server 320, which the game server uses to update game data in the game database 330 to reflect any and all changed conditions for the game.

In the embodiment shown in FIG. 3, the game server 320 includes a universal game module 322, a commercial game module 323, a data collection module 324, an event module 326, a mapping system 327, a training module 328, and a 3D map store 329. As mentioned above, the game server 320 interacts with a game database 330 that may be part of the game server or accessed remotely (e.g., the game database 330 may be a distributed database accessed via the network 370). In other embodiments, the game server 320 contains different or additional elements. In addition, the functions may be distributed among the elements in a different manner than described.

The universal game module 322 hosts an instance of the parallel reality game for a set of players (e.g., all players of the parallel reality game) and acts as the authoritative source for the current status of the parallel reality game for the set of players. As the host, the universal game module 322 generates game content for presentation to players (e.g., via their respective client devices 310). The universal game module 322 may access the game database 330 to retrieve or store game data when hosting the parallel reality game. The universal game module 322 may also receive game data from client devices 310 (e.g., depth information, player input, player position, player actions, landmark information, etc.) and incorporates the game data received into the overall parallel reality game for the entire set of players of the parallel reality game. The universal game module 322 can also manage the delivery of game data to the client device 310 over the network 370. In some embodiments, the universal game module 322 also governs security aspects of the interaction of the client device 310 with the parallel reality game, such as securing connections between the client device and the game server 320, establishing connections between various client devices, or verifying the location of the various client devices 310 to prevent players cheating by spoofing their location.

The commercial game module 323 can be separate from or a part of the universal game module 322. The commercial game module 323 can manage the inclusion of various game features within the parallel reality game that are linked with a commercial activity in the real world. For instance, the commercial game module 323 can receive requests from external systems such as sponsors/advertisers, businesses, or other entities over the network 370 to include game features linked with commercial activity in the real world. The commercial game module 323 can then arrange for the inclusion of these game features in the parallel reality game on confirming the linked commercial activity has occurred. For example, if a business pays the provider of the parallel reality game an agreed upon amount, a virtual object identifying the business may appear in the parallel reality game at a virtual location corresponding to a real-world location of the business (e.g., a store or restaurant).

The data collection module 324 can be separate from or a part of the universal game module 322. The data collection module 324 can manage the inclusion of various game features within the parallel reality game that are linked with a data collection activity in the real world. For instance, the data collection module 324 can modify game data stored in the game database 330 to include game features linked with data collection activity in the parallel reality game. The data collection module 324 can also analyze data collected by players pursuant to the data collection activity and provide the data for access by various platforms.

The event module 326 manages player access to events in the parallel reality game. Although the term “event” is used for convenience, it should be appreciated that this term need not refer to a specific event at a specific location or time. Rather, it may refer to any provision of access-controlled game content where one or more access criteria are used to determine whether players may access that content. Such content may be part of a larger parallel reality game that includes game content with less or no access control or may be a stand-alone, access controlled parallel reality game.

The mapping system 327 generates a 3D map of a geographical region based on a set of images. The 3D map may be a point cloud, polygon mesh, or any other suitable representation of the 3D geometry of the geographical region. The 3D map may include semantic labels providing additional contextual information, such as identifying objects tables, chairs, clocks, lampposts, trees, etc.), materials (concrete, water, brick, grass, etc.), or game properties (e.g., traversable by characters, suitable for certain in-game actions, etc.). In one embodiment, the mapping system 327 stores the 3D map along with any semantic/contextual information in the 3D map store 329. The 3D map may be stored in the 3D map store 329 in conjunction with location information (e.g., GPS coordinates of the center of the 3D map, a ringfence defining the extent of the 3D map, or the like). Thus, the game server 320 can provide the 3D map to client devices 310 that provide location data indicating they are within or near the geographic area covered by the 3D map.

The training module 328 trains models used for localization (e.g., by the localization module 318 of client devices 310). In one embodiment, the training module 328 trains the scene-agnostic map-relative pose regression model (i.e., network M). As described previously, the scene-agnostic map-relative pose regression model receives scene-specific information from a trained scene-specific model (i.e., network G) and outputs a pose without needing to be trained on the specific scene itself. The training module 328 may also train one or more scene-specific models (i.e., network G). Although the training module 328 is shown as part of the game server 320 for convenience, some or all of the functionality of the training module 328 may be provided to client devices 310 by another system or systems. For example, the models (e.g., one or both of network G and network M) may be trained by a development system and incorporated in an application that is downloaded to client devices 310 from an app store, or may be trained directly by the client devices 310 themselves.

The network 370 can be any type of communications network, such as a local area network (e.g., an intranet), wide area network (e.g., the internet), or some combination thereof. The network can also include a direct connection between a client device 310 and the game server 320. In general, communication between the game server 320 and a client device 310 can be carried via a network interface using any type of wired or wireless connection, using a variety of communication protocols (e.g., TCP/IP, HTTP, SMTP, FTP), encodings or formats (e.g., HTML, XML, JSON), or protection schemes (e.g., VPN, secure HTTP, SSL).

This disclosure makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, processes disclosed as being implemented by a server may be implemented using a single server or multiple servers working in combination. Databases and applications may be implemented on a single system or distributed across multiple systems. Distributed components may operate sequentially or in parallel.

In situations in which the systems and methods disclosed access and analyze personal information about users, or make use of personal information, such as location information, the users may be provided with an opportunity to control whether programs or features collect the information and control whether or how to receive content from the system or other application. No such information or data is collected or used until the user has been provided meaningful notice of what information is to be collected and how the information is used. The information is not collected or used unless the user provides consent, which can be revoked or modified by the user at any time. Thus, the user can have control over how information is collected about the user and used by the application or system. In addition, certain information or data can be treated in one or more ways before it is stored or used, so that personally identifiable information is removed. For example, a user's identity may be treated so that no personally identifiable information can be determined for the user.

### Example Methods

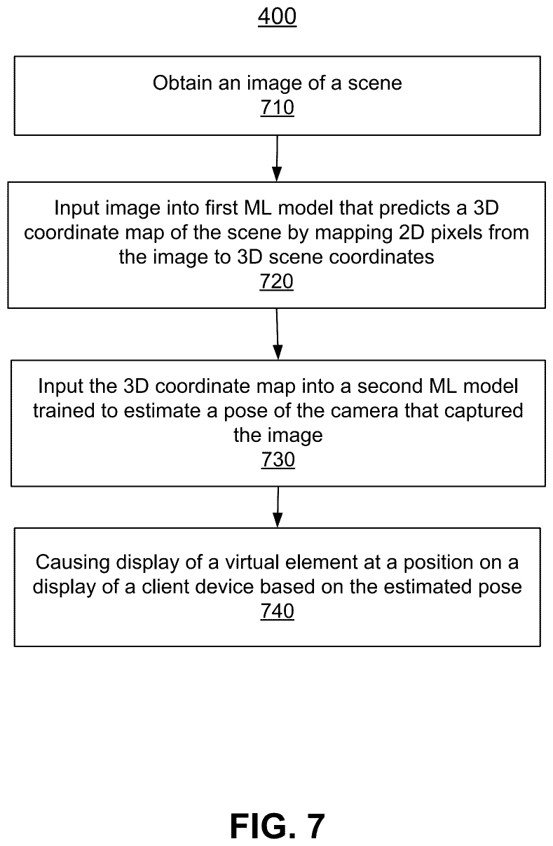

FIG. 7 is a flowchart describing an example method 700 of displaying virtual content using camera pose estimation using pose regression, according to one embodiment. The steps of FIG. 7 are illustrated from the perspective of the client device 310 performing the method 700. However, some or all of the steps may be performed by other entities or components. In addition, some embodiments may perform the steps in parallel, perform the steps in different orders, or perform different steps.

In the embodiment shown, the method 700 begins when the client device 310 obtaining 410 an image of a scene that was captured with the camera assembly 312. The client device 310 may input 420 the captured image into a first ML model, which is a scene-specific coordinate regression model (e.g., network G). The first ML model maps pixels from the image to 3D scene coordinates and outputs a coordinate map of the scene. The client device 310 may then input 430 the coordinate map of the scene into a second ML model, which is a scene-agnostic pose regressor model (e.g., network M). The second ML model may be trained by learning relationships between coordinate maps of historical scenes and corresponding camera poses to directly regress a camera pose based on the input coordinate map of the scene. The client device 310 may then cause 440 display of a virtual element at a location on a display of the client device 310 that is determined based on the camera pose output from the pose regressor model.

### Example Computing System

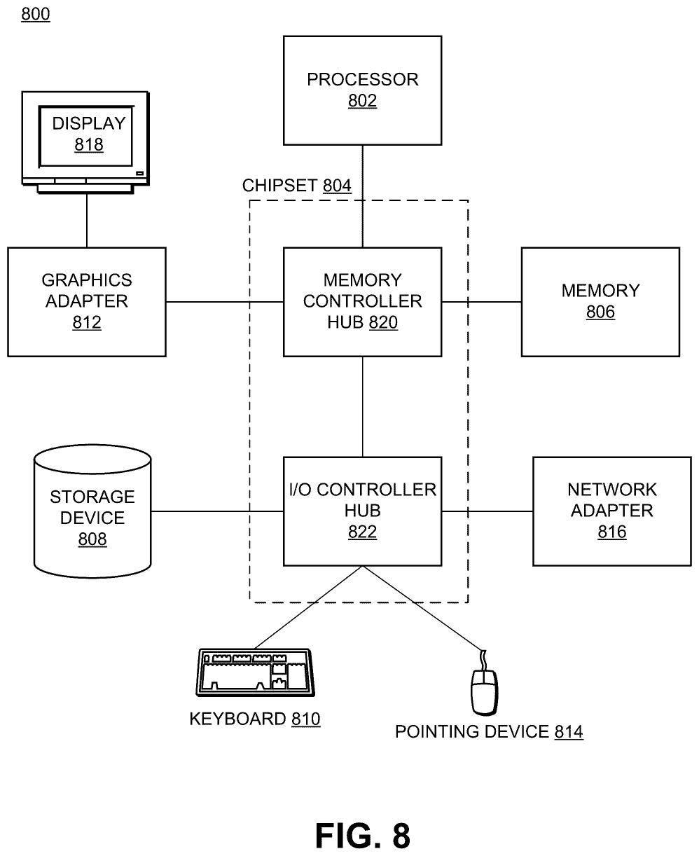

FIG. 8 is a block diagram of an example computer 800 suitable for use as a client device 310 or game server 320. The example computer 800 includes at least one processor 802 coupled to a chipset 804. References to a processor (or any other component of the computer 800) should be understood to refer to any one such component or combination of such components working cooperatively to provide the described functionality. The chipset 804 includes a memory controller hub 820 and an input/output (I/O) controller hub 822. A memory 806 and a graphics adapter 812 are coupled to the memory controller hub 820, and a display 818 is coupled to the graphics adapter 812. A storage device 808, keyboard 810, pointing device 814, and network adapter 816 are coupled to the I/O controller hub 822. Other embodiments of the computer 800 have different architectures.

In the embodiment shown in FIG. 8, the storage device 808 is a non-transitory computer-readable storage medium such as a hard drive, compact disk read-only memory (CD-ROM), DVD, or a solid-state memory device. The memory 806 holds instructions and data used by the processor 802. The pointing device 814 is a mouse, track ball, touchscreen, or other type of pointing device, and may be used in combination with the keyboard 810 (which may be an on-screen keyboard) to input data into the computer system 800. The graphics adapter 812 displays images and other information on the display 818. The network adapter 816 couples the computer system 800 to one or more computer networks, such as network 370.

The types of computers used by the entities of FIG. 3 can vary depending upon the embodiment and the processing power required by the entity. For example, the game server 320 might include multiple blade servers working together to provide the functionality described. Furthermore, the computers can lack some of the components described above, such as keyboards 810, graphics adapters 812, and displays 818.

### Additional Considerations

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

Any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate +/−10% unless another meaning is apparent from the context. From example, “approximately ten” should be understood to mean “in a range from nine to eleven.”

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for a system and a process for providing the described functionality. Thus, while particular embodiments and applications have been illustrated and described, it is to be understood that the described subject matter is not limited to the precise construction and components disclosed. The scope of protection should be limited only by the following claims.

What is claimed is:

1. A computer-implemented method for determining a camera pose, the method comprising:
obtaining an image of a scene captured by a camera;
inputting the image into a first machine-learned model trained to predict a 3D coordinate map of the scene by mapping 2D pixels from the image to 3D scene coordinates;
inputting the 3D coordinate map of the scene into a second machine-learned model trained to estimate a pose of the camera when capturing the image of the scene based on the 3D coordinate map; and
causing display of a virtual element at a position on a display of a client device, the position determined based on the pose of the camera estimated by the second machine-learned model.

2. The computer-implemented method of claim 1, wherein the image is an RGB image, and wherein the second machine-learned model estimates the pose of the camera without requiring a depth map or a point-cloud model of the image of the scene captured by the camera.

3. The computer-implemented method of claim 1, wherein the first machine-learned model is a scene-specific geometry-based prediction model that processes the captured image to predict the 3D coordinate map, the first machine-learned model having been trained specifically for the scene based on training data associated with the scene.

4. The computer-implemented method of claim 3, wherein the first machine-learned model is a convolutional neural network.

5. The computer-implemented method of claim 1, further comprising:
inputting a camera intrinsic matrix associated with the captured image into the second machine-learned model, wherein the second machine-learned model is a scene-agnostic pose regressor model that directly regresses a multi-dimensional pose vector for the captured image of the scene based on the 3D coordinate map and the camera intrinsic matrix associated with the captured image.

6. The computer-implemented method of claim 5, wherein the second machine-learned model is a transformer.

7. The computer-implemented method of claim 5, further comprising:
training the second machine-learned model using training data including 3D coordinate maps of a plurality of historical scenes and corresponding ground truth camera poses, wherein the second machine-learned model is agnostic to the scene.

8. The computer-implemented method of claim 1, wherein the pose of the camera indicates a position and an orientation of the camera relative to the 3D coordinate map of the scene, and wherein the method further comprises:
transmitting game data to the client device including the camera, the game data based on the pose of the camera.

9. The computer-implemented method of claim 1, wherein the first machine-learned model is a scene-specific geometry-based prediction model trained on images of the scene and the second machine-learned model is a scene-agnostic transformer model trained on images of a plurality of other scenes.

10. The computer-implemented method of claim 1, wherein the virtual element is displayed as part of an augmented reality experience in a game.

11. A non-transitory computer-readable medium storing instructions that, when executed by a computing system, cause the computing system to perform operations comprising:
obtaining an image of a scene captured by a camera;
inputting the image into a first machine-learned model predicts a 3D coordinate map of the scene by mapping 2D pixels from the image to 3D scene coordinates;
inputting the 3D coordinate map of the scene into a second machine-learned model trained to estimate a pose of the camera when capturing the image of the scene based on the 3D coordinate map; and
causing display of a virtual element at a position on a display of a client device, the position determined based on the pose of the camera estimated by the second machine-learned model.

12. The non-transitory computer-readable medium of claim 11, wherein the image is an RGB image, and wherein the second machine-learned model estimates the pose of the camera without requiring a depth map or a point-cloud model of the image of the scene captured by the camera.

13. The non-transitory computer-readable medium of claim 11, wherein the first machine-learned model is a scene-specific geometry-based prediction model that processes the captured image to predict the 3D coordinate map, the first machine-learned model having been trained specifically for the scene based on training data associated with the scene.

14. The non-transitory computer-readable medium of claim 13, wherein the first machine-learned model is a convolutional neural network.

15. The non-transitory computer-readable medium of claim 1, wherein the operations further comprise:
inputting a camera intrinsic matrix associated with the captured image into the second machine-learned model, wherein the second machine-learned model is a scene-agnostic pose regressor model that directly regresses a multi-dimensional pose vector for the captured image of the scene based on the 3D coordinate map and the camera intrinsic matrix associated with the captured image.

16. The non-transitory computer-readable medium of claim 15, wherein the second machine-learned model is a transformer.

17. The non-transitory computer-readable medium of claim 15, wherein the operations further comprise:
training the second machine-learned model using training data including 3D coordinate maps of a plurality of historical scenes and corresponding ground truth camera poses, wherein the second machine-learned model is agnostic to the scene.

18. The non-transitory computer-readable medium of claim 1, wherein the pose of the camera indicates a position and an orientation of the camera relative to the 3D coordinate map of the scene, and wherein the operations further comprise:
transmitting game data to the client device including the camera, the game data based on the pose of the camera.

19. The non-transitory computer-readable medium of claim 11, wherein the first machine-learned model is a scene-specific geometry-based prediction model trained on images of the scene and the second machine-learned model is a scene-agnostic transformer model trained on images of a plurality of other scenes.

20. A client device for detecting a camera pose, the client device comprising:
a display;
a camera;
one or more processors; and
memory storing a first and second machine-learned models, the memory further storing instructions that, when executed by the one or more processors, cause the one or more processors to perform operations comprising:
capturing an image of a scene by the camera;
inputting the image into a first machine-learned model predicts a 3D coordinate map of the scene by mapping 2D pixels from the image to 3D scene coordinates;
inputting the 3D coordinate map of the scene into a second machine-learned model trained to estimate a pose of the camera when capturing the image of the scene based on the 3D coordinate map; and
transmitting the estimated pose of the camera to a game server;
receiving game data from the game server, the game data based on transmitted pose of the camera; and
presenting a virtual element in a virtual world of an augmented reality game on the display of the client device based on the received game data.
